(19) United States
(12) Patent Application Publication
(10) Pub. No.: US 2023/0314671 A1
(43) Pub. Date: Oct. 5, 2023

(54) OPTICAL ELEMENT AND IMAGE PROJECTION DEVICE

(71) Applicant: KOITO MANUFACTURING CO., LTD., Tokyo (JP)

(72) Inventors: Yoichi Ogata, Shizuoka (JP); Mykyta Kolchiba, Shizuoka (JP)

(73) Assignee: KOITO MANUFACTURING CO., LTD., Tokyo (JP)

(21) Appl. No.: 18/009,484

(22) PCT Filed: Jun. 7, 2021
(86) PCT No.: PCT/JP2021/021549

§ 371 Date: Dec. 9, 2022

(30) Foreign Application Priority Data
Jun. 9, 2020 (JP) 2020-100442

(51) Int. Cl. G02B 5/18; G03B 21/20

(52) U.S. Cl. CPC G02B 5/1814; G03B 21/208

(57) ABSTRACT

An optical element includes a diffraction grating portion in which a plurality of protrusions and a plurality of recesses are periodically formed and a light guide plate portion that is made of a material having a refractive index different from that of the diffraction grating portion and that covers the diffraction grating portion. The light guide plate portion includes a first extending portion extending to one side, and a flat first light emitting portion is formed in the vicinity of an end portion of the first extending portion, and at least plus first order diffracted light of the diffracted light by the diffraction grating portion is totally reflected and guided in the first extending portion, and reaches the first light emitting portion.

### TECHNICAL FIELD

The present invention relates to an optical element and an image projection device, and particularly, relates to an optical element and an image projection device using a diffraction grating.

### BACKGROUND ART

In the related art, an instrument panel for lighting and displaying an icon is used as a device for displaying various kinds of information in a vehicle. It has also been proposed to, as the amount of information to be displayed increases, embed an image display device in the instrument panel or configure the entire instrument panel with an image display device.

Unfortunately, since the instrument panel is located below a windshield of the vehicle, it is not preferable for a driver to visually recognize information displayed on the instrument panel because it is necessary for the driver to move a line of sight downward during driving. Therefore, a head up display (hereinafter, referred to as HUD) that projects an image on the windshield and allows the driver to read information when viewing the front of the vehicle is also proposed (for example, see Patent Literature 1). In such an HUD, an optical device for projecting an image over a wide range of the windshield is required, and miniaturization and lightweight of the optical device is desired.

On the other hand, a head mounted HUD having a glasses shape is known as an image display device that projects light using a small optical device (for example, see Patent Literature 2). In the head mounted HUD, light emitted from a light source is directly emitted to eyes of a viewer to project an image on retinas of the viewer. In such a head mounted HUD, an optical element including a diffraction grating is used when light is emitted from a light source to the viewer. In such an HUD using an optical element including a diffraction grating, light is emitted from a light source to the diffraction grating at a predetermined incident angle, and diffracted light is guided inside the optical element and projected from a light emitting portion to the outside.

### CITATION LIST

### Patent Literature

Patent Literature 1: JP2018-118669A
Patent Literature 2: JP2018-528446T

### SUMMARY OF INVENTION

### Technical Problem

In order to project light from an optical element, it is necessary to provide a diffraction grating or a half mirror as an optical portion for light emission inside or outside a waveguide plate of the optical element. Unfortunately, forming the optical portion for light emission inside the optical element increases the number of manufacturing steps and makes it difficult to miniaturize the optical element. In order to provide an optical portion for light emission outside the optical element, it is also necessary to use a waveguide plate having a size capable of disposing the optical portion for light emission, and thus it is difficult to miniaturize the optical element. In addition, when an optical portion having a minute size is used as the optical portion for light emission, the positioning accuracy at the waveguide plate is required, the assembling process is complicated, and the manufacturing yield is reduced.

The present invention has been made in view of the above problems in the related art, and an object of the present invention is to provide an optical element and an image projection device which can guide diffracted light at a diffraction grating and emit the light to the outside by a simple structure, and which can be easily miniaturized.

### Solution to Problem

In order to solve the above problems, an optical element according to an aspect of the present invention includes a diffraction grating portion in which a plurality of protrusions and a plurality of recesses are periodically formed, and a light guide plate portion that is made of a material having a refractive index different from that of the diffraction grating portion and that covers the diffraction grating portion. The light guide plate portion includes a first extending portion extending to one side. A flat first light emitting portion is formed in the vicinity of an end portion of the first extending portion. At least one first order diffracted light of the diffracted light by the diffraction grating portion is totally reflected and guided in the first extending portion, and reaches the first light emitting portion.

In such an optical element according to an aspect of the present invention, at least one first order diffracted light of the diffracted light by the diffraction grating portion is totally reflected and guided in the first extending portion and reaches the first light emitting portion, and the light is extracted from the flat first light emitting portion to the outside of the optical element. Accordingly, it is possible to provide an optical element and an image projection device which can guide diffracted light at a diffraction grating and emit the light to the outside by a simple structure, and which can be easily miniaturized.

According to an aspect of the present invention, the light guide plate portion further includes a second extending portion extending to a side opposite to the first extending portion. A flat second light emitting portion is formed in the vicinity of an end portion of the second extending portion, and other second order diffracted light of the diffracted light by the diffraction grating portion is totally reflected and guided in the second extending portion, and reaches the second light emitting portion.

According to an aspect of the present invention, the protrusions constitute a slanted grating inclined by an angle φ with respect to a main surface, and the first extending portion extends to a side opposite to an inclination direction of the protrusions.

According to an aspect of the present invention, the first light emitting portion is provided at any one of an end surface, a front surface, and a back surface of the first extending portion.

According to an aspect of the present invention, 0 order diffracted light and other first order diffracted light of the diffracted light by the diffraction grating portion are transmitted through the main surface of the light guide plate portion and are emitted.

An image display device according to an aspect of the present invention includes the optical element according to any one of the above aspects, and a light guide portion optically coupled to the light guide plate portion and configured to guide light therein. The light guide portion includes a light incident portion that faces the first light emitting portion and a light emitting portion configured to emit the guided light.

According to an aspect of the present invention, a diffraction grating is formed in the light emitting portion.

According to an aspect of the present invention, a light source unit configured to irradiate the diffraction grating portion with light is provided, and the light source unit irradiates the diffraction grating portion with light from a direction inclined by an angle θ in an inclined direction of the protrusion.

### Advantageous Effects of Invention

According to the present invention, it is possible to provide an optical element and an image projection device which can guide diffracted light at a diffraction grating and emit the light to the outside by a simple structure, and which can be easily miniaturized.

### BRIEF DESCRIPTION OF DRAWINGS

FIG. 1 is a schematic cross-sectional diagram showing a structure of an optical element 10 according to a first embodiment.

FIG. 2 is a partially enlarged cross-sectional diagram showing a structure example of a diffraction grating portion 11.

FIG. 3 is a schematic cross-sectional diagram showing a structure of an image projection device 100 according to a second embodiment.

FIG. 4 is a schematic perspective view showing the structure of the image projection device 100 according to the second embodiment.

FIGS. 5A to 5C are schematic diagrams showing arrangement examples of the optical element 10 and a light guide portion 20 according to a third embodiment.

FIG. 6A and FIG. 6B are schematic diagrams showing light extraction in a case where a main surface of the optical element 10 faces a front surface or a back surface of the light guide portion 20.

FIGS. 7A to 7C are schematic diagrams showing light extraction in a case where an end surface of the optical element 10 faces an end surface of the light guide portion 20.

FIG. 8A and FIG. 8B are diagrams showing diffraction and travelling of light in the diffraction grating portion 11 according to a fourth embodiment, FIG. 8A is a schematic cross-sectional diagram, and FIG. 8B is a schematic perspective view.

FIG. 9A and FIG. 9B are graphs showing a simulation result of an electric field distribution according to the fourth embodiment, FIG. 9A is a graph showing an electric field Ey distribution when red light is incident, and FIG. 9B is a graph showing an electric field Ey distribution when green light is incident.

FIG. 10 is a schematic diagram showing an outline of an experimental device for detecting+1 order light I1 and −2 order light I2.

FIG. 11 is a perspective view schematically showing emission of the +1 order light I1 and the −2 order light I2 when incident light Lin to the optical element 10 is incident at an angle Θ.

FIG. 12 is a cross-sectional SEM photograph of the optical element 10.

FIG. 13 is a graph showing a relation between the incident angle θ of the incident light Lin and an intensity of light emitted from the optical element 10, which is measured using a red laser as a light source in the device shown in FIG. 10.

FIGS. 14A to 14D are photographs showing an experiment in the device shown in FIG. 10, FIG. 14A shows irradiation with red light in a state where illumination is turned on, FIG. 14B shows irradiation with red light in a state where illumination is turned off, FIG. 14C shows irradiation with green light in a state where illumination is turned on, and FIG. 14D shows irradiation with green light in a state where illumination is turned off.

FIG. 15A is a schematic diagram showing an outline of an experimental device for observing a far-field image by the +1 order light I1 emitted from the optical element 10, and FIG. 15B is a diagram showing a structure of a test target arranged between a lens and a mirror M2.

FIGS. 16A to 16F are photographs showing an experiment in the device shown in FIG. 15A and FIG. 15B, FIGS. 16A to 16C show a case where red light is incident, and FIGS. 16D to 16F show a case where red light is incident. Enlarged diagrams shown in FIG. 16A and FIG. 16D show a shape of the incident light Lin at a position between the mirror M3 and the lens in FIG. 15A and FIG. 15B.

FIG. 17 is a diagram showing an observation result of the far-field image when the test target is moved in a horizontal direction in the device shown in FIG. 15A.

FIGS. 18A to 18F are photographs showing a far-field image observed on a screen, FIGS. 18A to 18C show a case where red light is incident, and FIGS. 18D to 18F show a case where green light is incident.

FIG. 19A and FIG. 19B are graphs showing a light intensity distribution in the far-field image, FIG. 19A shows a case of red, and FIG. 19B shows a case of green.

FIG. 20A and FIG. 20B are diagrams showing deformation of a projection image according to a projection distance, FIG. 20A is a schematic diagram showing a distribution of diffraction angles in a case where the incident light Lin is focused and emitted to the optical element 10, and FIG. 20B is a schematic diagram showing a change in far-field image.

### DESCRIPTION OF EMBODIMENTS

### First Embodiment

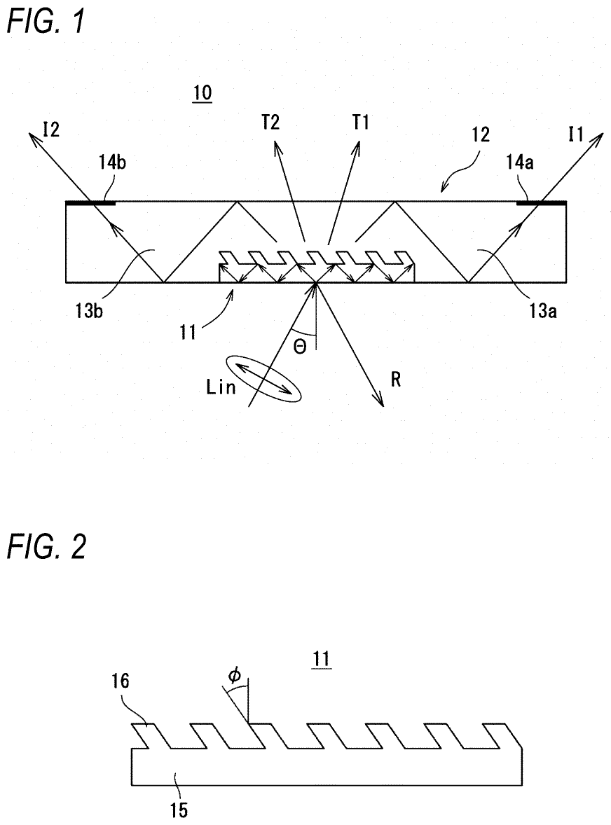

Hereinafter, embodiments of the present invention will be described in detail with reference to the drawings. The same or equivalent components, members, and processing shown in the drawings are denoted by the same reference numerals, and repeated description thereof will be omitted as appropriate. FIG. 1 is a schematic cross-sectional diagram showing a structure of an optical element 10 according to the present embodiment. As shown in FIG. 1, the optical element 10 includes a diffraction grating portion 11 and a light guide plate portion 12 that covers the diffraction grating portion 11. The diffraction grating portion 11 is an optical portion in which a plurality of protrusions and a plurality of recesses are periodically formed. The light guide plate portion 12 is a substantially flat plate-shaped member made of a material having a refractive index different from that of the diffraction grating portion 11. FIG. 1 schematically shows the structure of the optical element 10, and dimensions and angles in the drawing do not show actual dimensions in the optical element 10.

FIG. 2 is a partially enlarged cross-sectional diagram showing a structure example of the diffraction grating portion 11. As shown in FIG. 2, the diffraction grating portion 11 includes a substantially flat plate-shaped portion 15 and a plurality of protrusions 16 formed on a main surface of the plate-shaped portion 15. The plate-shaped portion 15 and the protrusions 16 are integrally formed of the same material. The plurality of protrusions 16 are periodically arranged, and a recess is formed between adjacent protrusions 16. In the example shown in FIG. 1, the protrusions 16 and the recesses of the diffraction grating portion 11 extend in a stripe shape in a depth direction of a paper surface. The protrusions 16 are inclined by a predetermined angle φ with respect to the main surface of the plate-shaped portion 15, and constitutes a slanted grating.

As shown in FIG. 1, a groove having the shape of the diffraction grating portion 11 is formed on one surface of the light guide plate portion 12, and the diffraction grating portion 11 is implemented by embedding the material of the diffraction grating portion 11 in the groove. Therefore, the light guide plate portion 12 covers the diffraction grating portion 11.

In the light guide plate portion 12, a plate-shaped first extending portion 13a extends to one side from an area in which the diffraction grating portion 11 is formed, and a flat first light emitting portion 14a is provided in the vicinity of an end portion of the first extending portion 13a. Similarly, in the light guide plate portion 12, a plate-shaped second extending portion 13b extends to the other side from the area where the diffraction grating portion 11 is formed, and a flat second light emitting portion 14b is provided in the vicinity of an end portion of the second extending portion 13b.

Although the material constituting the diffraction grating portion 11 is not limited, it is preferable to use a material having a large difference in refractive index from the light guide plate portion 12, and it is preferable to use, for example, a dielectric having a refractive index of about 2.5 and containing TiO₂ as a main component. The diffraction grating portion 11 can be formed by a known method, and for example, a photolithography technique, a nanoimprint technique, or an electron beam lithography (EBL) technique can be used. By holding the light guide plate portion 12 in an inclined state and using a reactive ion etching (ME) method or the like, the protrusion 16 can be inclined by an angle φ.

A size of the diffraction grating portion 11 is not particularly limited, but it is preferable that the diffraction grating portion 11 has a thickness capable of guiding light also in an in-plane direction, and for example, a total thickness h is about 788±12 nm, a height d of the protrusion 16 is about 210±10.5 nm, a width w of the protrusion 16 is about 230 nm, and a pitch A of the protrusion 16 is about 696 nm. A size of the light guide plate portion 12 is not limited, but may be, for example, about 15 mm in width d and about 0.5 to 20 mm in thickness t. The material constituting the light guide plate portion 12 is not limited, but it is preferable to use, for example, glass or a polymer containing SiO₂ as a main component.

The inclination angle φ of the protrusion 16 is preferably in a range of −45 degrees or more and 45 degrees or less. When the inclination angle φ is out of the above range, it is difficult to form the protrusion 16, an area where the protrusion 16 overhangs above the recess becomes too large, a periodic refractive index difference in the plane of the diffraction grating portion 11 becomes small, and a function of the diffraction grating is deteriorated. When the inclination angle φ is too small, the protrusion 16 becomes close to a pillared grating perpendicular to the main surface of the diffraction grating portion 11, and an advantage of the slanted grating is less likely to occur. Here, shapes of the protrusion 16 and the recess constituting the slanted grating include not only a case where side surfaces of the protrusion 16 are inclined parallel to each other but also a case where inclinations of both side surfaces of the protrusion 16 are different from each other. At this time, the inclination angle φ of the protrusion 16 is an angle formed between a line connecting centers of an upper end and a lower end of the protrusion 16 and the main surface of the diffraction grating portion 11.

Next, an optical path in the optical element 10 will be described with reference to FIG. 1. FIG. 1 schematically shows, using arrows, travelling of light in the optical element 10, and does not reflect an accurate incident position, travelling path, and emission position of light.

Laser light is emitted from a light source unit (not shown) toward the optical element 10. Here, the laser light is coherent light having a uniform phase, and is emitted as collimated light by a collimator lens or the like. Incident light Lin emitted from the light source unit is incident on an interface of the diffraction grating portion 11 at the inclination angle θ, a part of the incident light Lin is reflected as reflected light R at the interface, and the other light is incident on the diffraction grating portion 11. Here, the inclination angle θ of the incident light Lin and the inclination direction of the protrusion 16 in the diffraction grating portion 11 are the same direction. A polarization direction of the incident light Lin is parallel to the stripe of the protrusion 16.

A part of the light incident into the diffraction grating portion 11 reaches the inside of the light guide plate portion 12 as diffracted light at a predetermined angle due to the difference in refractive index between the periodic protrusions 16 and the light guide plate portion 12, and a part of the light is propagated as propagating light in the plane of the plate-shaped portion 15 of the diffraction grating portion 11 as leakage propagating light.

In the example shown in FIG. 1, 0 order light T1 of the light diffracted by the diffraction grating portion 11 is transmitted through the light guide plate portion 12 and emitted to the outside of the light guide plate portion 12. First order light (−1 order light T2) diffracted in the direction in which the protrusion 16 is inclined is also transmitted through the light guide plate portion 12 and emitted to the outside of the light guide plate portion 12. A reason is that the 0 order light T1 and the −1 order light T2 are diffracted at an angle close to being perpendicular to the main surfaces of the diffraction grating portion 11 and the light guide plate portion 12, and do not satisfy a total reflection condition at an interface between the light guide plate portion 12 and an air layer.

First order light (+1 order light I1) diffracted in a direction opposite to the inclination of the protrusion 16 is totally reflected by the interface between the light guide plate portion 12 and the air layer, propagates in the first extending portion 13a, reaches the flat first light emitting portion 14a at the end portion of the first extending portion 13a, and is emitted to the outside of the light guide plate portion 12. Similarly, second order light (−2 order light I2) diffracted in the inclined direction of the protrusion 16 is totally reflected by the interface between the light guide plate portion 12 and the air layer, propagates in the second extending portion 13b, reaches the flat second light emitting portion 14b at the end portion of the second extending portion 13b, and is emitted to the outside of the light guide plate portion 12.

The total reflection condition at the interface between the light guide plate portion 12 and the air layer is determined by the refractive index of the material constituting the light guide plate portion 12. Therefore, the diffraction grating portion 11 is designed so that diffraction angles of the +1 order light I1 and the −2 order light I2 diffracted by the diffraction grating portion 11 satisfy the total reflection condition. By setting the inclination angle θ of the incident light from the light source unit to satisfy the diffraction condition and the total reflection condition, as shown in FIG. 1, the +1 order light I1 and the −2 order light I2 can be totally reflected in the light guide plate portion 12 and reach the first light emitting portion 14a and the second light emitting portion 14b, respectively.

Here, the first light emitting portion 14a and the second light emitting portion 14b are flat surfaces, and light cannot be extracted when the total reflection condition is satisfied, and thus light extraction is performed by, for example, forming an antireflection film or a refractive index adjustment film for reducing a refractive index difference from the air layer. As will be described later, another light guide member may be arranged close to the first light emitting portion 14a and the second light emitting portion 14b to propagate light to the other light guide member.

The 0 order light T1, the −1 order light T2, the +1 order light I1, and the −2 order light 12 emitted from the light guide plate portion 12 are represented by linear arrows in FIG. 1, for simplicity, although being actually refracted and changed in angle due to a difference in refractive index between the light guide plate portion 12 and the outside.

As described above, in the optical element 10 according to the present embodiment, the plus first order diffracted light (+1 order light I1) diffracted to the side opposite to the inclination of the protrusion 16 in the diffracted light by the diffraction grating portion 11 is totally reflected and guided in the first extending portion 13 and reaches the first light emitting portion 14a, and light is extracted from the flat first light emitting portion 14a to the outside of the optical element. Accordingly, the diffracted light at the diffraction grating portion 11 can be guided and emitted to the outside by a simple structure, and miniaturization becomes easy.

The minus second order diffracted light (−2 order light I2) diffracted to the same side as the inclination of the protrusion 16 in the diffracted light by the diffraction grating portion 11 is totally reflected and guided in the second extending portion 13b and reaches the second light emitting portion 14b, and light is extracted from the flat first light emitting portion 14 to the outside of the optical element. Accordingly, only by irradiating one diffraction grating portion 11 with the incident light Lin from one light source unit, the −2 order light I2 can also be propagated in the direction opposite to the +1 order light I1.

The 0 order diffracted light (0 order light T1) and the minus first order diffracted light (−1 order light T2) diffracted to the same side as the inclination of the protrusion 16 in the diffracted light by the diffraction grating portion 11 are extracted to the outside from the area where the diffraction grating portion 11 is formed. Accordingly, in addition to the +1 order light I1 and the −2 order light I2, light can be further emitted in two directions.

### Second Embodiment

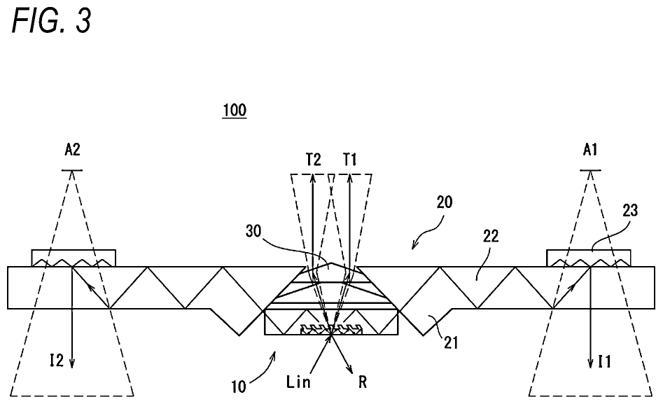

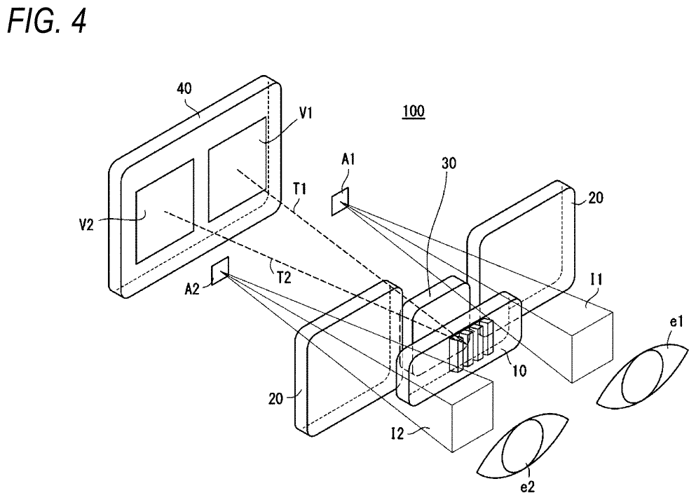

Next, a second embodiment of the present invention will be described with reference to FIGS. 3 and 4. The description of the same contents as those of the first embodiment will be omitted. FIG. 3 is a schematic cross-sectional diagram showing a structure of an image projection device 100 according to the present embodiment. FIG. 4 is a schematic perspective view showing the structure of the image projection device 100 according to the present embodiment. As shown in FIGS. 3 and 4, the image projection device 100 includes the optical element 10 described in the first embodiment, a light guide portion 20, a prism portion 30, and a projection plate portion 40. The light guide portion 20 includes a light incident portion 21, a waveguide portion 22, and a light emitting portion 23.

The light guide portion 20 is an optical member provided adjacent to the optical element 10, and is made of a material transparent to light emitted from the optical element 10. The light incident portion 21 is formed in an area of the light guide portion 20 that faces the first light emitting portion 14a and the second light emitting portion 14b of the optical element 10, and light that propagates inside the optical element 10 and reaches the first light emitting portion 14a and the second light emitting portion 14b is taken into the light guide portion 20. The light guide portion 20 includes the waveguide portion 22 integrally formed of the same material as the light incident portion 21, and the light from the light incident portion 21 propagates in the waveguide portion 22 while being totally reflected, and reaches the light emitting portion 23. The light emitting portion 23 is an optical portion for extracting light from the light guide portion 20 to the outside, and for example, a diffraction grating can be used.

FIG. 3 shows a shape in which an end surface of the waveguide portion 22 is inclined as the light incident portion 21, but the shape is not limited as long as the light incident portion 21 faces the first light emitting portion 14a and the second light emitting portion 14b of the optical element 10. A gap may be provided between the light incident portion 21 and the first light emitting portion 14a as well as between the light incident portion 21 and the second light emitting portion 14b, or the light incident portion 21, the first light emitting portion 14a, and the second light emitting portion 14b may be in contact with one another. In FIG. 3, the waveguide portion 22 has a flat plate shape, but the waveguide portion 22 may have a curved surface shape as long as light can be totally reflected and propagated therein. The diffraction grating of the light emitting portion 23 may be implemented by forming a groove in a part of the waveguide portion 22, or may be implemented separately from the waveguide portion 22 and bonded thereto.

The prism portion 30 is an optical member arranged on an optical path in which the 0 order light T1 and the −1 order light T2 of the optical element 10 are emitted, and changes an emission direction by refracting the 0 order light T1 and the −1 order light T2. FIG. 3 shows a structure in which two prisms are stacked as the prism portion 30, but a larger number of prisms may be used, or a single prism may be used. A lens or the like may be used instead of the prism portion 30. The prism portion 30 may be formed separately from the light guide portion 20, or may be formed integrally with the light guide portion 20.

The projection plate portion 40 is a member arranged on the optical path of the 0 order light T1 and the −1 order light T2, and is implemented by a member that reflects at least a part of the 0 order light T1 and the −1 order light T2. When the 0 order light T1 and the −1 order light T2 reach the projection plate portion 40, a part of the light is reflected, and thus a viewer can visually recognize an image with the light emitted by the 0 order light T1 and the −1 order light T2. A specific material of the projection plate portion 40 is not limited, but paper, resin, glass, or the like can be used. A windshield of a vehicle or a helmet, a screen, a wall surface, or the like can be used as the projection plate portion 40.

As shown in FIGS. 3 and 4, the incident light Lin emitted from the light source unit is incident on the diffraction grating portion 11 of the optical element 10 at the incident angle Θ, a part of the incident light Lin is reflected as the reflective light R, and a part of the incident light Lin reaches the inside of the diffraction grating portion 11. The light that reaches the inside of the diffraction grating portion 11 is diffracted in a direction that satisfies the diffraction condition. The 0 order light T1 and the −1 order light T2 from the diffraction grating portion 11 are transmitted through the light guide plate portion 12, are incident on the prism portion 30, and are emitted to a front side of the image projection device 100 (upper side of paper surface in FIG. 3). The +1 order light I1 and the −2 order light I2 from the diffraction grating portion 11 reach the light incident portion 21 from the first light emitting portion 14a and the second light emitting portion 14b, respectively, are totally reflected in the waveguide portion 22 and reach the light emitting portion 23, and are emitted to a rear side of the image projection device 100 (lower side of paper surface in FIG. 3).

The 0 order light T1 and the −1 order light T2 emitted from the light emitting portion 23 reach a viewpoint of the viewer while increasing a light diameter. Accordingly, for the viewer, the optical path becomes the same as that of the light which is focused and travels farther than the light guide portion 20, and the viewer visually recognizes air real images A1 and A2 in a space. The 0 order light T1 and the −1 order light T2 emitted to the front side via the prism portion 30 project projection images V1 and V2 on a front surface of the projection plate portion 40, respectively. Therefore, the viewer can visually recognize the air real images A1 and A2 formed in the space and the projection images V1 and V2 projected on the front surface of the projection plate portion 40 at the same time. Here, when forming positions of the air real images A1 and A2 are designed to be between the projection images V1 and V2 and the viewpoint, the projection images V1 and V2 and the air real images A1 and A2 can be visually recognized in a superimposed manner.

As described above, in the image projection device 100 according to the present embodiment, by arranging the light guide portion 20 adjacent to the optical element 10, light that propagates inside the optical element 10 and reaches the first light emitting portion 14a and the second light emitting portion 14b can be favorably guided, and light can be emitted to the outside by the light emitting portion 23. Using the optical element described in the first embodiment as the optical element 10, the diffracted light at the diffraction grating portion 11 can be guided and emitted to the outside by a simple structure, and miniaturization becomes easy.

Although the optical element 10 has strict restrictions such as diffraction conditions, total reflection conditions, and the incident angle θ of the incident light Lin, and thus has a low degree of freedom, by implementing the light guide portion 20 separately from the optical element 10, it is possible to adjust a light emission direction only by changing the design of the waveguide portion 22 and the light emitting portion 23, and thus the degree of freedom in design of the entire image projection device 100 is improved.

By arranging the prism portion 30 in front of the optical element 10, it is possible to project the 0 order light T1 and the −1 order light T2 emitted from the optical element 10 on appropriate positions and display the projection images V1 and V2.

### Third Embodiment

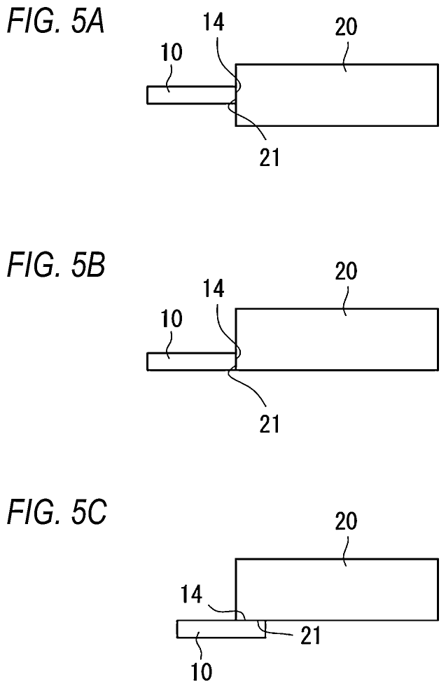

Next, a third embodiment of the present invention will be described with reference to FIGS. 5A to 7C. Descriptions of the same contents as those of the second embodiment will be omitted. In the present embodiment, another structure example for performing optical coupling between the optical element 10 and the light guide portion 20 will be described. FIGS. 5A to 5C are schematic diagrams showing arrangement examples of the optical element and the light guide portion 20 according to the present embodiment.

In the example shown in FIG. 5A, the light emitting portion 14 (first light emitting portion 14a and second light emitting portion 14b) is provided on an end surface of the optical element 10, and the light incident portion 21 is provided on an end surface of the light guide portion 20. In addition, the light emitting portion 14 and the light incident portion 21 face each other at a substantially central position in a thickness direction of the light guide portion 20.

In the example shown in FIG. 5B, the light emitting portion 14 is provided on an end surface of the optical element 10, and the light incident portion 21 is provided on an end surface of the light guide portion 20. The light emitting portion 14 and the light incident portion 21 face each other at a position close to a front surface or a back surface of the light guide portion 20.

In the example shown in FIG. 5C, the light emitting portion 14 is provided on a main surface of the optical element 10, the light incident portion 21 is provided on a front surface or a back surface of the light guide portion 20, and the light emitting portion 14 and the light incident portion 21 face each other.

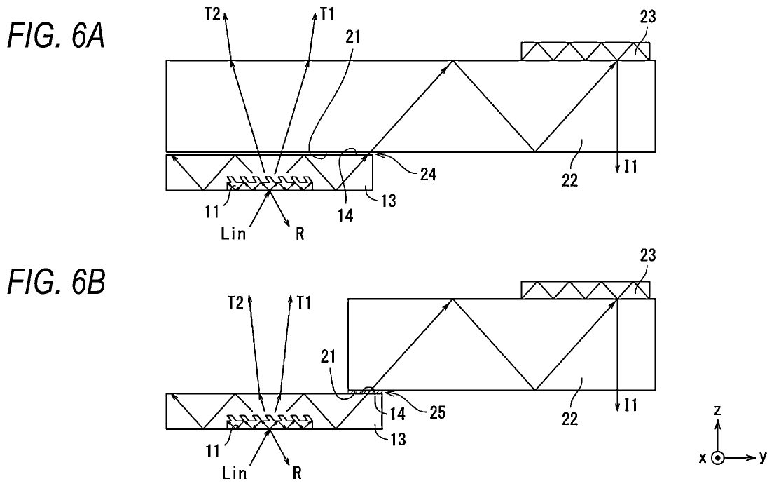

FIG. 6A and FIG. 6B are schematic diagrams showing light extraction in a case where the main surface of the optical element 10 faces the front surface or the back surface of the light guide portion 20. FIG. 6A shows an example in which the light guide portion 20 covers the entire main surface of the optical element 10, and FIG. 6B shows an example in which the light guide portion 20 is arranged only in the extending portion 13 (first extending portion 13a and second extending portion 13b) except for an area where the diffraction grating portion 11 is provided. FIG. 6A shows an example in which a gap 24 is provided between the light emitting portion 14 of the optical element 10 and the light incident portion 21 of the light guide portion 20, and FIG. 6B shows an example in which a refractive index adjustment layer 25 is formed in the gap 24.

Here, the gap 24 is preferably set to a distance at which the light propagating in the extending portion 13 can be optically coupled so that the light propagates to the waveguide portion 22 without being totally reflected by the light emitting portion 14. Specifically, the distance is preferably, for example, 100λμm or shorter. The refractive index adjustment layer 25 is preferably made of a material having a refractive index close to that of a material constituting the extending portion 13 and the waveguide portion 22, and for example, a refractive index difference between the extending portion 13 and the waveguide portion 22 is preferably 0.26 or less. As the refractive index adjustment layer 25, for example, a contact liquid having a refractive index of 1.52 can be used. In addition, the extending portion 13 and the waveguide portion 22 may not be optically coupled to each other, the gap 24 having a distance for totally reflecting light may be provided at an interface between the extending portion 13 and an air layer, and the refractive index adjustment layer 25 may be provided only between the light emitting portion 14 and the light incident portion 21.

As shown in FIG. 6A and FIG. 6B, the incident light Lin emitted to the diffraction grating portion 11 is diffracted by the diffraction grating portion 11, the 0 order light T1 and the −1 order light T2 are emitted, and the +1 order light I1 and the −2 order light I2 are totally reflected and propagated in the extending portion 13. Since an emitting angle of the diffracted light is determined by a wavelength, an incident position, and an incident angle of the incident light Lin and an optical design of the diffraction grating portion 11, a position of the light emitting portion 14 can be determined by appropriately setting a thickness of the light guide plate portion 12 and a length of the extending portion 13.

The light that reaches the light emitting portion 14 propagates into the waveguide portion 22 from the light incident portion 21 that faces the light emitting portion 14 with the gap 24 or the refractive index adjustment layer 25 interposed therebetween. The light incident into the waveguide portion 22 propagates in the light guide portion 20 while being totally reflected, reaches the light emitting portion 23, and is emitted to the outside. Here, a light emitting position and a light emitting angle of the light incident on the light incident portion 21 from the light emitting portion 14 are determined by the wavelength, the incident position, and the incident angle of the incident light Lin and the optical design of the diffraction grating portion 11 as described above. Therefore, it is possible to cause light to reach the light emitting portion 23 by appropriately setting a thickness, a shape, and a length of the light guide portion 20.

FIG. 6A and FIG. 6B show an example in which the light emitting portion 14 is provided on a front surface side of the main surface of the optical element 10 where the diffraction grating portion 11 is not provided, but the light emitting portion 14 may be provided on a back surface side of the main surface of the optical element 10 where the diffraction grating portion 11 is provided. In this case, the light incident portion 21 is provided on the front surface side of the light guide portion 20, and the optical element 10 faces the front surface side of the light guide portion 20.

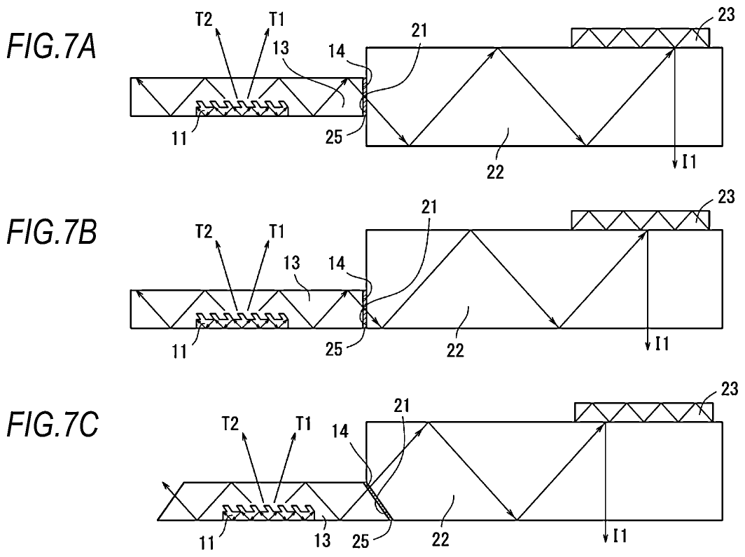

FIGS. 7A to 7C are schematic diagrams showing light extraction in a case where the end surface of the optical element 10 faces the end surface of the light guide portion 20. In the example shown in FIG. 7A, the light emitting portion 14 and the light incident portion 21 face each other at a substantially central position in the thickness direction of the light guide portion 20. In the example shown in FIG. 7B, the light emitting portion 14 and the light incident portion 21 face each other at a position close to the front surface or the back surface of the light guide portion 20. In the example shown in FIG. 7C, a part of the end surface of the optical element 10 and a part of the end surface of the light guide portion 20 are inclined, and respective inclined surfaces face the light emitting portion 14 and the light incident portion 21. FIGS. 7A to 7C show examples in which the refractive index adjustment layer 25 is provided between the light emitting portion 14 and the light incident portion 21, but a gap 24 may be provided between the light emitting portion 14 and the light incident portion 21 to interpose an air layer therebetween.

Since in the examples shown in FIGS. 7A to 7C, the emitting angle of the diffracted light is also determined by the wavelength, the incident position, and the incident angle of the incident light Lin and the optical design of the diffraction grating portion 11, the position of the light emitting portion 14 can be determined by appropriately setting the thickness of the light guide plate portion 12 and the length of the extending portion 13. In addition, it is possible to cause light to reach the light emitting portion 23 by appropriately setting the thickness, the shape, and the length of the light guide portion 20.

In the optical element 10 according to the present embodiment, since the light emitting portion 14 (first light emitting portion 14a and second light emitting portion 14b) is a flat surface, coupling of light propagating inside can be performed only by forming the light incident portion 21 of the light guide portion 20 of a flat surface and making the light incident portion 21 face the light emitting portion 14. Accordingly, in the optical element 10, the diffracted light at the diffraction grating portion 11 can be guided and emitted to the outside by a simple structure, and miniaturization becomes easy.

By providing the light emitting portion 14 on the front surface, the back surface, or the end surface of the extending portion 13 (first extending portion 13a and second extending portion 13b), it is possible to use a substantially flat plate-shaped member as the light guide plate portion 12 without requiring any special processing. By setting the end surface of the extending portion 13 as an inclined surface and providing the light emitting portion 14 on the inclined surface, the light totally reflected and propagated in the extending portion 13 does not satisfy the total reflection condition in the light emitting portion 14, and the light can be favorably propagated to the light incident portion 21.

### Fourth Embodiment

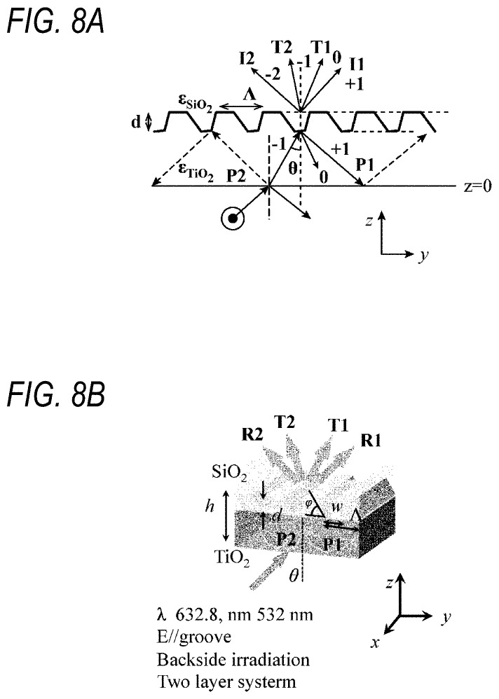

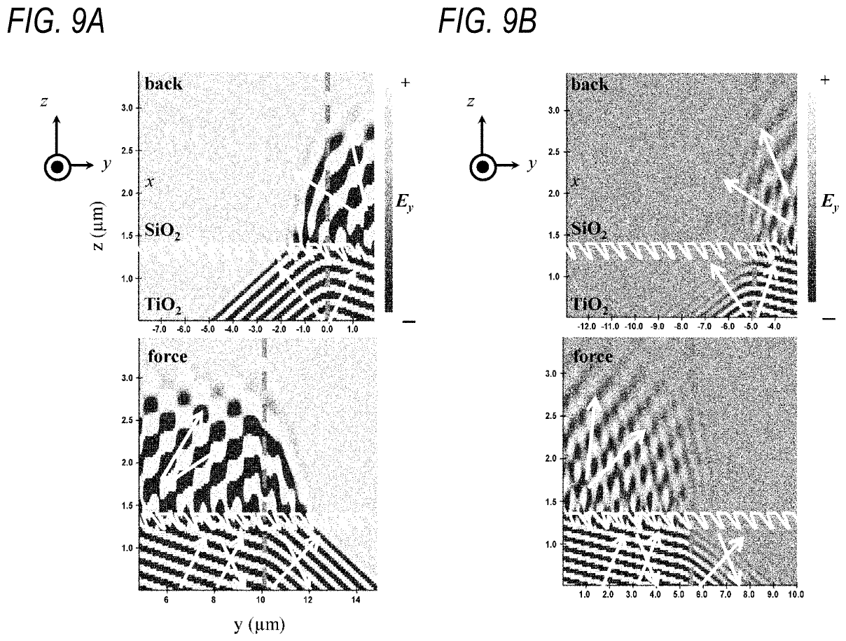

Next, a fourth embodiment of the present invention will be described with reference to FIGS. 8A to 14D. The description of the same contents as those of the first embodiment will be omitted. FIG. 8A and FIG. 8B are diagrams showing diffraction and travelling of light in the diffraction grating portion 11 in the present embodiment, FIG. 8A is a schematic cross-sectional diagram, and FIG. 8B is a schematic perspective view. In FIG. 8A, a direction perpendicular to the paper surface is defined as an x axis, a rightward direction on the paper surface is defined as a y axis, and an upward direction on the paper surface is defined as a z axis. The x axis, the y axis, and the z axis shown in FIG. 8B indicate the same directions as FIG. 8A. FIG. 9A and FIG. 9B are graphs showing a simulation result of an electric field distribution in the present embodiment, FIG. 9A is a graph showing a simulation result of an electric field Ey distribution when red light is incident, and FIG. 9B is a graph showing a simulation result of an electric field Ey distribution when green light is incident.

As shown in FIG. 8A and FIG. 8B, the diffraction grating portion 11 is made of TiO₂ having an overall thickness h, and a slanted grating is formed by forming recesses in an inclined direction with respect to the main surface. The light guide plate portion 12 made of SiO₂ is formed on the diffraction grating portion 11 so as to cover the protrusions 16 and the recesses (not shown). The protrusion 16 has a height of d, a width of W, and a pitch of A, and is inclined by the angle φ in the −y direction. The incident light Lin is polarized in the x-axis direction, and is incident from a direction inclined by the angle θ in the −y direction from a direction perpendicular to the back surface of the diffraction grating portion 11.

FIG. 9A and FIG. 9B show simulation results of the electric field Ey distribution using a finite difference time domain (FDTD) method when wavelengths of the incident light Lin are 632.8 nm in red and 532 nm in green, respectively. In the drawing, a horizontal axis indicates a position in a y-axis direction in which the protrusions 16 and the recesses are periodically arranged, and a vertically extending broken line indicates an outer peripheral position of a light diameter of the incident light Lin. In the drawing, a vertical axis indicates a position in a z-axis direction, which is a height direction, and an origin indicates the back surface of the diffraction grating portion 11. In the drawing, a grating shape is shown in white, and grayscale in the drawing shows the electric field distribution.

As simulation conditions, the refractive index of the diffraction grating portion 11 is 2.52, the refractive index of the light guide plate portion 12 is 1.54, and the refractive index of air is 1.00. The pitch A between the protrusion 16 and the recess is 704 nm, the width W of the protrusion 16 is 230 nm, the height d of the protrusion 16 is 210 nm, and the thickness h of the entire diffraction grating portion 11 is 1.0 μm. The incident light Lin has a divergence angle of 6.12 degrees with a diameter of 10 μm. The inclination angle φ of the slanted grating is 55 degrees. The incident angle Θ of the incident light Lin to the back surface of the diffraction grating portion 11 is 23 degrees.

The graphs shown in upper parts of FIG. 9A and FIG. 9B show a left side of the incident position of the incident light Lin, and show the light traveling in the −y direction from the incident position of the incident light Lin. The graphs shown in lower parts of FIG. 9A and FIG. 9B show a right side of the incident position of the incident light Lin, and show the light traveling in the +y direction from the incident position of the incident light Lin. Arrows shown in the drawing are propagation vectors of the light inside the optical element 10.

As shown in FIG. 9A and FIG. 9B, light traveling rearward of the incident position of the incident light Lin and light traveling forward as leakage propagating light are present in the diffraction grating portion 11. The light diffracted by the slanted grating travels as the 0 order light T1, the −1 order light T2, the +1 order light I1, and the −2 order light I2 in the light guide plate portion 12.

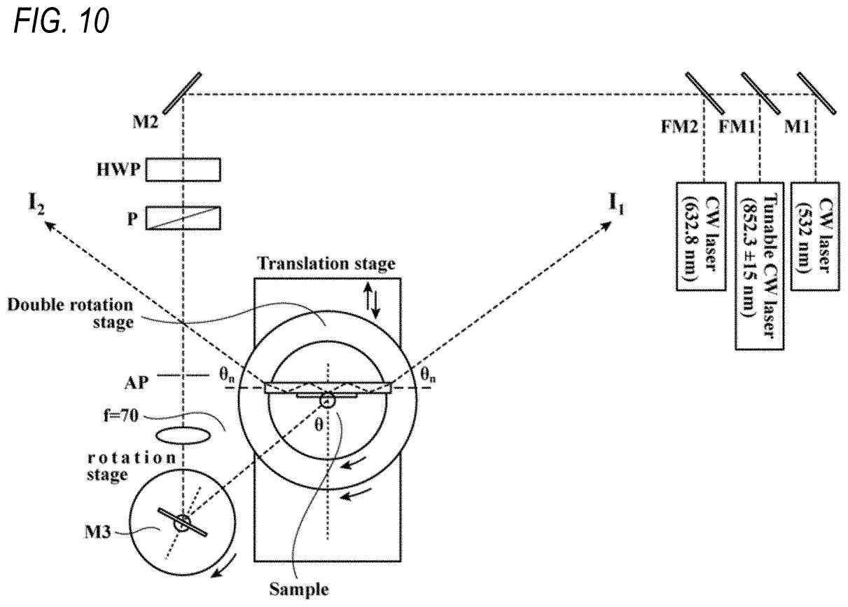

Next, the optical element 10 including the diffraction grating portion 11 described above is prepared, and an experiment is performed in which the +1 order light I1 and the −2 order light I2 are detected by emitting the incident light Lin. FIG. 10 is a schematic diagram showing an outline of an experimental device for detecting the +1 order light I1 and the −2 order light I2. As a light source, a green laser (continuous light having a wavelength of 532 nm), a wavelength tunable laser (continuous light having a wavelength of 852.3±15 nm), and a red laser (continuous light having a wavelength of 632.8 nm) are prepared.

A mirror M1 and flip mirrors FM1 and FM2 are arranged on the optical paths of the three light sources, respectively, and the light is caused to reach a mirror M2 in the same optical path. The light reflected by the mirror M2 reaches a mirror M3 via a half waveplate HWP, a polarizer P, an aperture AP, and a lens. The mirror M3 is arranged on a rotation stage, and an angle thereof with respect to the optical path is variable in accordance with rotation of the rotation stage. The optical element 10 is arranged on a double rotation stage, and the double rotation stage is arranged on a translation stage. The light that reaches the mirror M3 is reflected, is incident on the diffraction grating portion 11 of the optical element 10, and is totally reflected in the light guide plate portion 12, and the +1 order light I1 and the −2 order light I2 are emitted from the first light emitting portion 14a and the second light emitting portion 14b, respectively.

Although when the rotation stage is rotated and the incident angle of the light on the mirror M3 is changed, the position at which the reflected light from the mirror M3 reaches changes, the reflected light can be incident on the diffraction grating portion 11 by moving the double rotation stage on the translation stage in a vertical direction in the drawing. In addition, it is possible to change the angle θ at which the reflected light from the mirror M3 is incident on the diffraction grating portion 11 by rotating the double rotation stage. Therefore, it is possible to measure a relation between the incident angle Θ of the incident light Lin to the diffraction grating portion 11 and emission light intensities of the +1 order light I1 and the −2 order light I2 by arranging a light receiving device in the emission direction of the +1 order light I1 and the −2 order light I2.

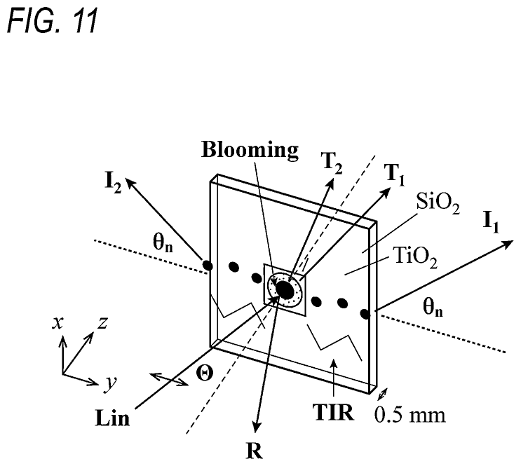

FIG. 11 is a perspective view schematically showing emission of the +1 order light I1 and the −2 order light I2 when the incident light Lin to the optical element 10 is incident at the angle Θ. Light emission occurs in the diffraction grating portion 11 on which the incident light Lin is incident, and blooming of total internal reflection (TIR) occurs in the first extending portion 13a and the second extending portion 13b. The +1 order light I1 and the −2 order light I2 are emitted to the outside from the first light emitting portion 14a and the second light emitting portion 14b which are provided at end portions of the first extending portion 13a and the second extending portion 13b, respectively. In addition, the 0 order light T1 and the −1 order light T2 are emitted from the main surface of the optical element 10 in the area where the diffraction grating portion 11 is provided.

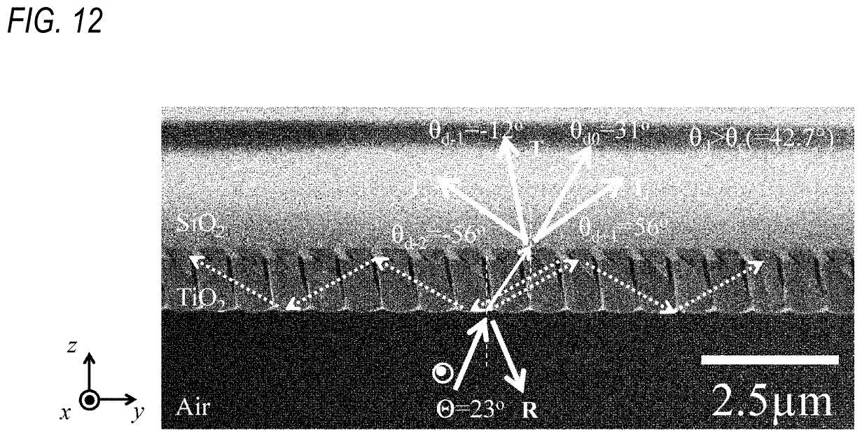

FIG. 12 is a cross-sectional SEM photograph of the optical element 10. A lower area in the drawing is an air layer, and the diffraction grating portion 11 made of TiO₂ and the light guide plate portion 12 made of SiO₂ that covers the diffraction grating portion 11 are stacked. As shown in the drawing, a direction perpendicular to the paper surface is the x-axis direction, a rightward direction in the drawing is the y-axis direction, and an upward direction in the drawing is the z-axis direction. Arrows drawn in the air layer schematically indicate the incident position of the incident light Lin and the reflected light R. Solid-line arrows shown in the diffraction grating portion 11 indicate optical paths of the incident light Lin diffracted by the slanted grating, and broken-line arrows schematically indicate leakage propagating light. Arrows shown in the light guide plate portion 12 indicate traveling directions of the 0 order light T1, the −1 order light T2, the +1 order light I1, and the −2 order light 12 diffracted by the diffraction grating portion 11, respectively.

As shown in FIG. 12, when the incident angle θ of the incident light Lin is 23 degrees, the 0 order light T1 is diffracted in a direction of 31 degrees, the −1 order light T2 is diffracted in a direction of −12 degrees, the +1 order light I1 is diffracted in a direction of 56 degrees, and the −2 order light I2 is diffracted in a direction of −56 degrees. According to the refractive indices of the light guide plate portion 12 and the air layer, the total reflection condition at the light guide plate portion 12 is 42.7 degrees, and the +1 order light I1 and the −2 order light I2 satisfy the total reflection condition.

FIG. 13 is a graph showing a relation between the incident angle θ of the incident light Lin and an intensity of light emitted from the optical element 10, which is measured using a red laser as a light source in the device shown in FIG. 10. A line plotted by circles indicates the emission light intensity of the +1 order light I1. A line plotted by triangles indicates the emission light intensity of the −2 order light I2. A line plotted by large squares indicates the total emission light intensity of the 0 order light T1 and the −1 order light T2. A line plotted by small squares indicates the emission light intensity of the reflected light R.

As shown in FIG. 13, the +1 order light I1 is observed in a range of 22 degrees≤Θ≤27 degrees, and a maximum emission light intensity is obtained in a range of 23 degrees≤Θ≤25 degrees. In addition, the −2 order light I2 is observed in ranges of 23 degrees≤Θ≤25 degrees and 35 degrees≤Θ≤37.5 Degrees, and a maximum emission light intensity is obtained in the range of 23 degrees≤Θ≤25 degrees. Therefore, when the light emitted by the light source unit is red, the +1 order light I1 can be emitted from the first light emitting portion 14a by setting the incident angle Θ of the incident light Lin in a range of 20 degrees or more and 30 degrees or less. In addition, it is possible to simultaneously emit the +1 order light I1 from the first light emitting portion 14a and the −2 order light I2 from the second light emitting portion 14b by setting the incident angle Θ to be in a range of 23 degrees or more and 25 degrees or less. In addition, the −2 order light I2 can be selectively emitted only from the second light emitting portion 14b by setting the incident angle Θ in the range of 35 degrees or more and 37.5 degrees or less.

When the light emitted by the light source unit is green, the incident angle Θ of the incident light Lin is preferably in a range of 15.0 degrees or more and 30.0 degrees or less, and more preferably in a range of 17.0 degrees or more and 18.0 degrees or less.

When the light emitted by the light source unit is blue, the incident angle Θ of the incident light Lin is preferably in a range of 0 degrees or more and 11.0 degrees or less, and more preferably in a range of 5.0 degrees or more and 6.0 degrees or less.

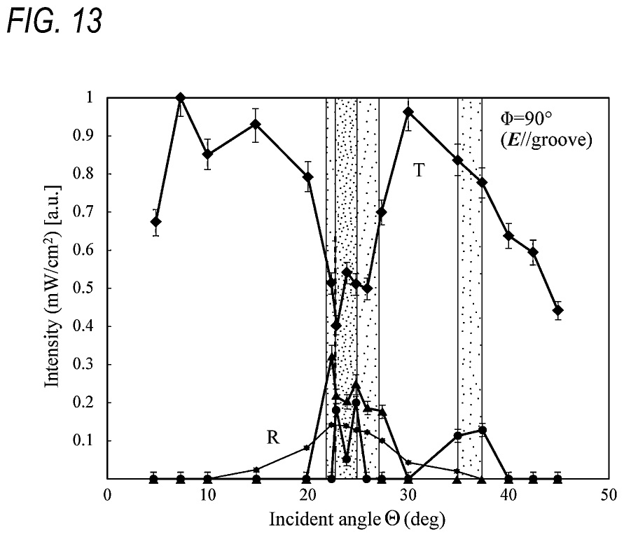

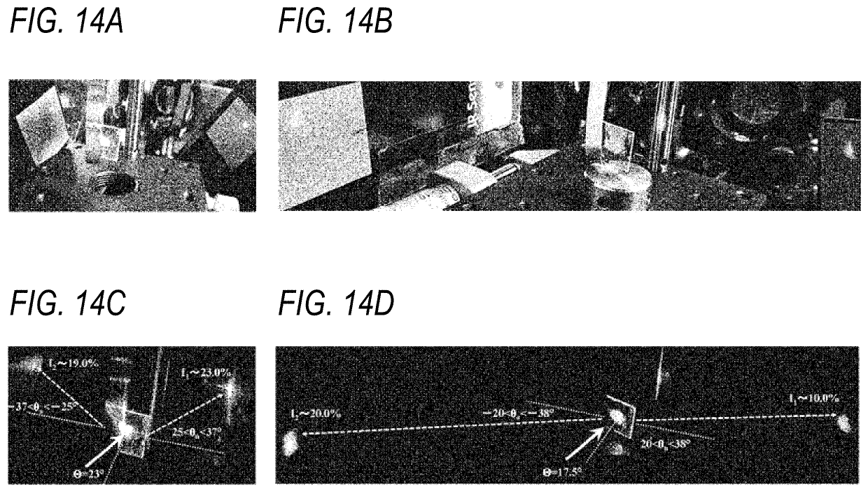

FIGS. 14A to 14D are photographs showing an experiment in the device shown in FIG. 10, FIG. 14A shows irradiation with red light in a state where illumination is turned on, FIG. 14B shows irradiation with red light in a state where illumination is turned off, FIG. 14C shows irradiation with green light in a state where illumination is turned on, and FIG. 14D shows irradiation with green light in a state where illumination is turned off.

As shown in FIG. 14A and FIG. 14B, when red light is emitted from Θ=23 degrees, the +1 order light I1 and the −2 order light I2 are simultaneously emitted, and the emission direction is a direction from 25 degrees to 37 degrees from the direction perpendicular to the main surface of the optical element 10. When the light intensity of the incident light Lin is 100%, the light intensity of the +1 order light I1 is 23.0%, and the light intensity of the −2 order light I2 is 19.0%.

As shown in FIG. 14C and FIG. 14D, when the green light is emitted from Θ=17.5 degrees, the +1 order light I1 and the −2 order light I2 are simultaneously emitted, and an emission direction is a direction from 20 degrees to 38 degrees from the direction perpendicular to the main surface of the optical element 10. When the light intensity of the incident light Lin is 100%, the light intensity of the +1 order light I1 is 10.0%, and the light intensity of the −2 order light I2 is 20.0%. Here, in the experimental examples shown in FIG. 14C and FIG. 14D, the emission direction of the −2 order light I2 is a light incident surface side of the optical element 10. However, by appropriately setting the length of the second extending portion 13b and setting the number of times of total reflection to be the same as that of the +1 order light I1, the light can be emitted to the same surface side as that of the +1 order light I1.

Similarly, when blue light is emitted from Θ=5.5 degrees, the +1 order light I1 and the −2 order light I2 are simultaneously emitted. When the light intensity of the incident light Lin is 100%, the light intensities of the +1 order light I1 and the −2 order light I2 have the same values as those of the red light and the green light.

As described above, in the optical element 10 according to the present embodiment, it is also possible to guide the diffracted light at the diffraction grating portion 11 and emit the light to the outside by a simple structure, and miniaturization becomes easy. In addition, it is possible to select the emission of the +1 order light I1 from the first light emitting portion 14a and the emission of the −2 order light I2 from the second light emitting portion 14b by setting the incident angle Θ of the incident light Lin within an appropriate range.

### Fifth Embodiment

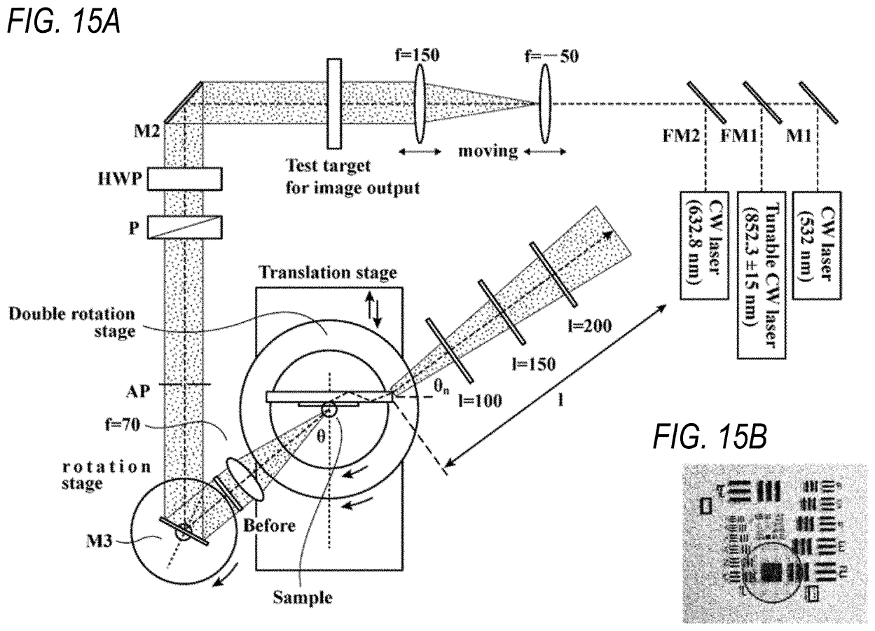

Next, a fifth embodiment of the present invention will be described with reference to FIGS. 15A to 20B. The description of the same contents as those of the first embodiment will be omitted. FIG. 15A is a schematic diagram showing an outline of an experimental device for observing a far-field image by the +1 order light I1 emitted from the optical element 10.

As shown in FIG. 15A, a green laser, a wavelength tunable laser, and a red laser are prepared as light sources. The mirror M1 and the flip mirrors FM1 and FM2 are arranged on optical paths of the three light sources, respectively, and light is caused to reach the mirror M2 through a plurality of lenses and a test target in the same optical path. The light reflected by the mirror M2 reaches the mirror M3 through the half waveplate HWP, the polarizer P, and the aperture AP. The light that reaches the mirror M3 is reflected, is incident on the diffraction grating portion 11 of the optical element 10 through the lens, and is totally reflected inside the light guide plate portion 12, and the +1 order light I1 is emitted from the first light emitting portion 14a. A screen is placed on the optical path of the +1 order light I1, and far-field images are observed at positions at distances of 100 mm, 150 mm, and 200 mm from the first light emitting portion 14a.

FIG. 15B shows a structure of the test target arranged between the lens and the mirror M2. The test target is a member in which black patterns for blocking light is formed on a transparent plate, the emitted light is blocked in an area where the pattern is formed, and the light is transmitted through the area where the pattern is not formed. A circle drawn in FIG. 15B indicates a light diameter of the light emitted from the light source unit, and the light is blocked by the pattern arranged in the circle, and thus the shape of the light incident on the optical element 10 is a shape in which a rectangular non-irradiation area is provided at the center of the circle.

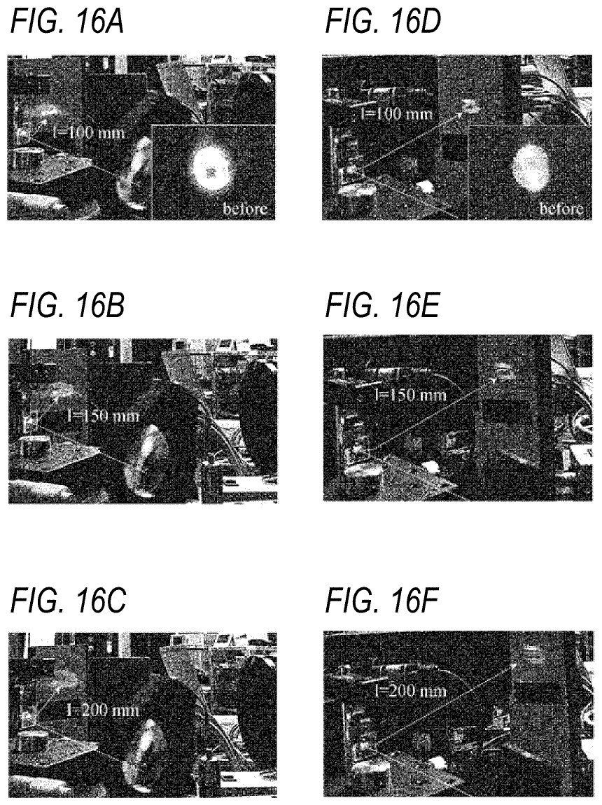

FIGS. 16A to 14F are photographs showing an experiment in the device shown in FIG. 15A and FIG. 15B, FIGS. 16A to 16C show a case where red light is incident, and FIGS. 16D to 16F show a case where green light is incident. FIG. 16A and FIG. 16D are observations at a position of 100 mm, FIG. 16B and FIG. 16E are observations at a position of 150 mm, and FIG. 16C and FIG. 16F are observations at a position of 200 mm. Enlarged diagrams shown in FIG. 16A and FIG. 16D show a shape of the incident light Lin at a position between the mirror M3 and the lens in 15A and FIG. 15B.

An arrow indicated by a broken line in the drawing represents an optical path of the incident light Lin and the +1 order light I1, and a far-field image is observed on the screen placed ahead of the arrow. In any of FIGS. 16A to 14F, a rectangular non-irradiation area is formed substantially at the center of the area irradiated with light. Therefore, in the optical element 10 according to the present embodiment, it can be confirmed that a far-field image reflecting the shape of the incident light Lin is formed.

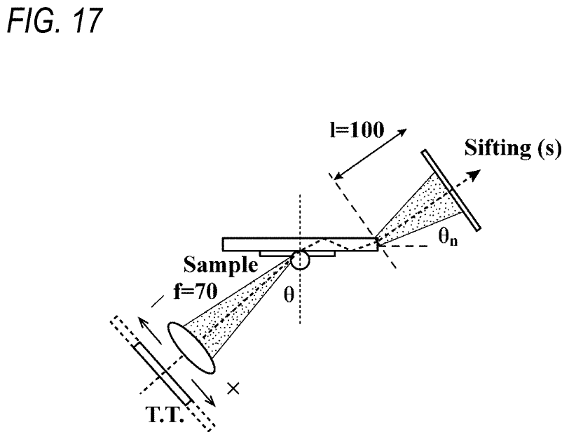

FIGS. 17 to 19B are diagrams showing observation results of the far-field image when the test target is moved in a horizontal direction in the device shown in FIG. 15A. FIG. 17 is a schematic diagram showing the movement direction of the test target (T. T.) and observation on the far-field image. The position of the screen is set to 100 mm. The test target shown in FIG. 15B is used.

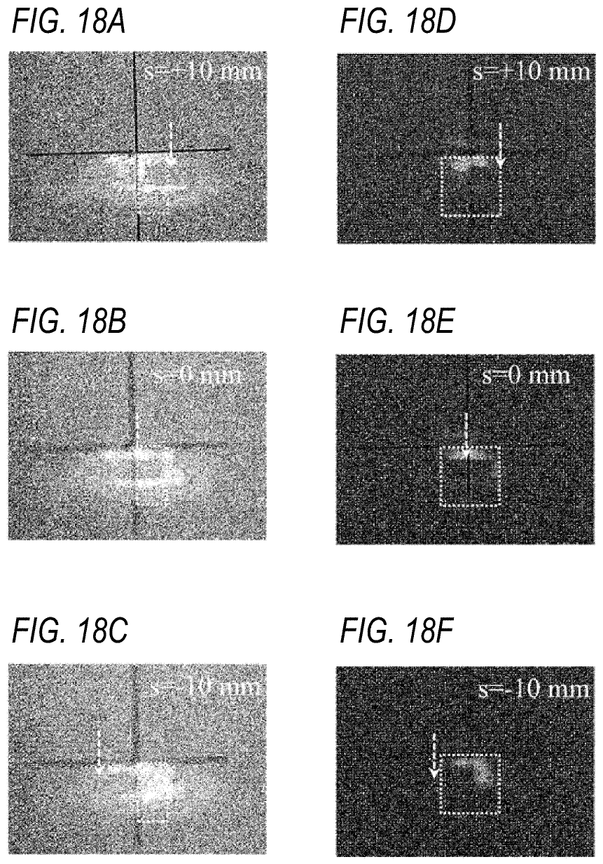

FIGS. 18A to 18F are photographs showing the far-field image observed on a screen, FIGS. 18A to 18C show a case where red light is incident, and FIGS. 18D to 18F show a case where green light is incident. A movement amount of the test target is +10 mm in FIG. 18A and FIG. 18D, 0 mm in FIG. 18B and FIG. 18E, and −10 mm in FIG. 18C and FIG. 18F. A broken line arrow shown in the drawing indicates a position of one side of a rectangular pattern in the test target. As shown in FIGS. 18A to 18F, it can be confirmed that as the test target is moved in the horizontal direction, the far-field image projected on the screen is also moved.

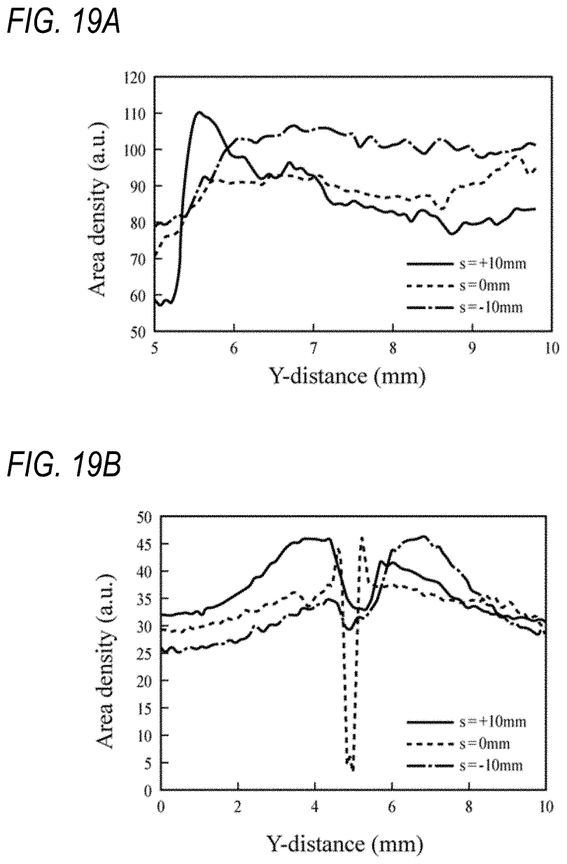

FIG. 19A and FIG. 19B are graphs showing a light intensity distribution in the far-field image, FIG. 19A shows a case of red, and FIG. 19B shows a case of green. In the graphs, the darkest line indicates a movement of +10 mm, the thinnest line indicates a movement of 0 mm, and a line having a medium density indicates a movement of −10 mm. A horizontal axis indicates the position in the horizontal direction on the screen, and drop in the graphs in the vicinity of 5 mm corresponds to the non-irradiation area where the light is blocked by the rectangular pattern. As shown in FIG. 19A and FIG. 19B, it can be confirmed that the non-irradiation area is moved in accordance with the movement of the test pattern.

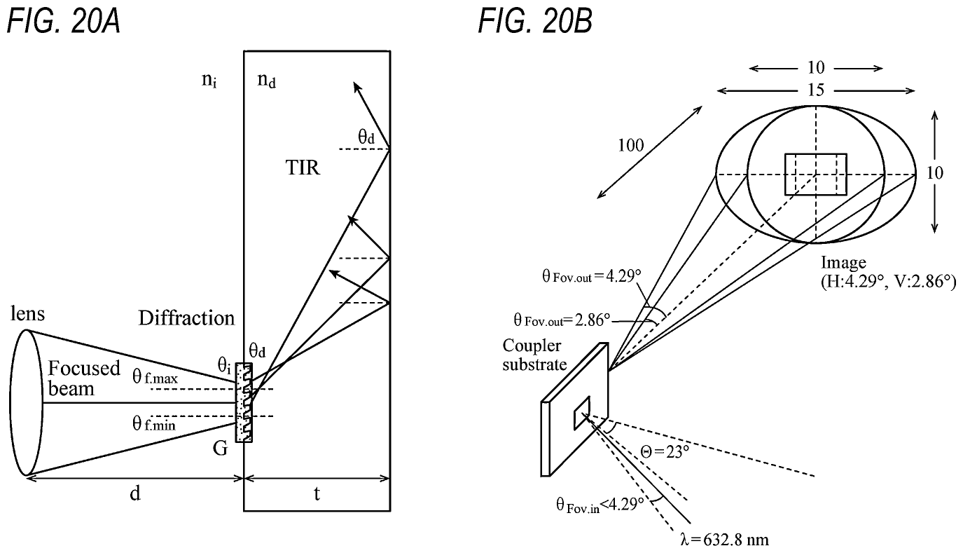

FIG. 20A and FIG. 20B are diagrams showing deformation of a projection image according to a projection distance, FIG. 20A is a schematic diagram showing a distribution of diffraction angles in a case where the incident light Lin is focused and emitted to the optical element 10, and FIG. 20B is a schematic diagram showing a change in far-field image.

As shown in FIG. 20A, the incident angle of the incident light Lin focused by the lens when the incident light Lin reaches the diffraction grating portion 11 varies depending on the irradiation area. Therefore, the traveling direction of the diffracted light by the slanted grating of the diffraction grating portion 11 varies depending on an in-plane position of the diffraction grating portion 11, and the path of propagation by total reflection (TIR) in the light guide plate portion 12 also varies. Accordingly, as shown in FIG. 20B, the +1 order light I1 and the −2 order light I2 are enlarged in an uniaxial direction when the projection distance is 100 mm. As the projection distance becomes longer, the image is further enlarged in the uniaxial direction. Therefore, it is possible to prevent the enlargement deformation due to the projection distance and project the image having the same aspect ratio by using an image in which the shape of the image is compressed in the uniaxial direction in advance according to the projection distance or by arranging a lens for correcting the enlargement in the uniaxial direction on a light emission side.

As described above, in the optical element 10 according to the present embodiment, a projection image in which the image shape of the incident light Lin is reflected can be projected as a far-field image. It is also possible to change the projection position of the far-field image in accordance with the movement of the image. In addition, since the projection image is enlarged in the uniaxial direction according to the projection distance, the aspect ratio of the projection image can be kept constant by compressing the image in the uniaxial direction according to the distance.

The present invention is not limited to the embodiments described above, various modifications can be made within the scope of the claims, and embodiments obtained by appropriately combining technical means disclosed in different embodiments are also included in the technical scope of the present invention.

The present application is based on Japanese Patent Application No. 2020-100442 filed on Jun. 9, 2020, and the contents thereof are incorporated herein as reference.

### INDUSTRIAL APPLICABILITY

According to the present invention, it is possible to provide an optical element and an image projection device which can guide diffracted light at a diffraction grating and emit the light to an outside by a simple structure, and which can be easily miniaturized.

### REFERENCE SIGNS LIST

100 image projection device
10 optical element
20 light guide portion
30 prism portion
40 projection plate portion
11 diffraction grating portion
12 light guide plate portion
13 extending portion
13a first extending portion
13b second extending portion
14 light emitting portion
14a first light emitting portion
14b second light emitting portion
15 plate-shaped portion
16 protrusion
21 light incident portion
22 waveguide portion
23 light emitting portion
24 gap
25 refractive index adjustment layer

1. An optical element comprising:
a diffraction grating portion in which a plurality of protrusions and a plurality of recesses are periodically formed; and
a light guide plate portion that is made of a material having a refractive index different from that of the diffraction grating portion and that covers the diffraction grating portion, wherein
the light guide plate portion includes a first extending portion extending to one side, and a flat first light emitting portion is formed in the vicinity of an end portion of the first extending portion, and
at least plus first order diffracted light of the diffracted light by the diffraction grating portion is totally reflected and guided in the first extending portion, and reaches the first light emitting portion.

2. The optical element according to claim 1, wherein
the light guide plate portion further includes a second extending portion extending to a side opposite to the first extending portion, and a flat second light emitting portion is formed in the vicinity of an end portion of the second extending portion, and
minus second order diffracted light of the diffracted light by the diffraction grating portion is totally reflected and guided in the second extending portion, and reaches the second light emitting portion.

3. The optical element according to claim 1, wherein
the protrusions constitute a slanted grating inclined with respect to a main surface, and
the first extending portion extends to a side opposite to an inclination direction of the protrusions.

4. The optical element according to claim 1, wherein
the first light emitting portion is provided at any one of an end surface, a front surface, and a back surface of the first extending portion.

5. The optical element according to claim 1, wherein
0 order diffracted light and minus first order diffracted light of the diffracted light by the diffraction grating portion are transmitted through the main surface of the light guide plate portion and are emitted.

6. An image projection device comprising:
the optical element according to claim 1; and
a light guide portion optically coupled to the light guide plate portion and configured to guide light therein, wherein
the light guide portion includes a light incident portion that faces the first light emitting portion and a light emitting portion configured to emit the guided light.

7. The image projection device according to claim 6, wherein
a diffraction grating is formed in the light emitting portion.

8. The image projection device according to claim 6, further comprising:
a light source unit configured to irradiate the diffraction grating portion with light, wherein
the light source unit irradiates the diffraction grating portion with light from a direction inclined with respect to an inclination direction of the protrusion.
